(19) United States
(12) Patent Application Publication
(10) Pub. No.: US 2013/0086486 A1
(43) Pub. Date: Apr. 4, 2013

(54) Mutable Message Attributes

(71) Applicant: Michael James Ahiakpor, San Francisco, CA (US)

(72) Inventor: Michael James Ahiakpor, San Francisco, CA (US)

(21) Appl. No.: 13/250,582

(22) Filed: Sep. 30, 2011

(51) Int. Cl. G06F 3/01; G06F 15/16

(52) U.S. Cl. 715/752

(57) ABSTRACT

Mutable message attribute techniques are described. In one or more implementations, functionality is exposed, via a user interface, that is configured to receive one or more inputs to specify an action and one or more conditions for an attribute of a message that is mutable over time. A rule is configured to perform the action to one or more messages in accordance with the one or more conditions for the attribute that is mutable over time.

### BACKGROUND

The amount of messages with which a typical user may interact in a given day is ever increasing. For example, a user may receive a multitude of emails that vary in an amount of importance to a recipient of the emails. The user, for instance, may receive work emails and personal emails in an account. The user may also receive emails that are sent periodically from a sender that may have varying degrees of interest to the user, such as newsletters, offers for sale, and so on.

However, traditional techniques that were employed to interact with the emails generally did not differentiate between these emails. Consequently, a user was often forced to navigate through each of the emails using traditional techniques to locate a particular email of interest, which could be both time consuming and frustrating to the user especially when considering the vast number of emails and other messages even a typical user may receive in a day.

### SUMMARY

Mutable message attribute techniques are described. In one or more implementations, functionality is exposed, via a user interface, that is configured to receive one or more inputs to specify an action and one or more conditions for an attribute of a message that is mutable over time. A rule is configured to perform the action to one or more messages in accordance with the one or more conditions for the attribute that is mutable over time.

In one or more implementations, a rule is configured based on one or more inputs received from a user via a user interface, the rule defining a particular sender, an action to be performed on messages received from the particular sender, and one or more conditions for an attribute of the messages that is mutable over time. One or more messages received from the particular sender at a user's account are managed based on the rule.

In one or more implementations, a determination is made as whether to perform an action on an email received from a sender specified in a rule based on whether one or more conditions for an attribute of the message that is mutable over time has been met. Responsive to the determination that the one or more conditions are met by the email, the action is performed on the email.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ deferred condition techniques.

FIG. 2 is an illustration of a user interface in an example implementation that exposes functionality to specify deferred conditions for an attribute of a message.

FIG. 3 is a flow diagram depicting a procedure in an example implementation in which a rule is configured to perform an action in accordance with one or more conditions for a mutable attribute.

FIG. 4 is a flow diagram depicting a procedure in an example implementation in which a rule that specifies one or more conditions for a mutable attribute is used to manage messages received from a sender.

FIG. 5 is a flow diagram depicting a procedure in an example implementation in which an action is performed responsive to a determination that one or more conditions for a mutable attribute of a message are met by the message.

FIG. 6 illustrates an example system that includes the computing device as described with reference to FIG. 1.

FIG. 7 illustrates various components of an example device that can be implemented as any type of computing device as described with reference to FIGS. 1, 2, and 6 to implement embodiments of the techniques described herein.

### DETAILED DESCRIPTION

Overview

Users may utilize messaging (e.g., email, texts, MMS, instant messages, and so on) as a primary means of communication. Because of this, however, even a typical user may receive a multitude of different messages from a wide variety of different sources in a given day, which may make interaction with the messages difficult using conventional techniques. For example, conventional rules were typically inflexible and lacked a richness to address more than basic situations, e.g., is message from “x.”

Mutable message attribute techniques are described. In one or more implementations, functionality may be exposed to define rules that include a condition. For example, the rule may define a deferred action (e.g., delete messages from a particular sender after 30 days) so that the rule may be executed in the future. Further, the rule may be configured to take into account attributes of the messages that may change over time, such as whether the message was flagged by a user as important. Thus, these techniques may support rich rules that may address a variety of different attributes and conditions for the attributes, further discussion of which may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

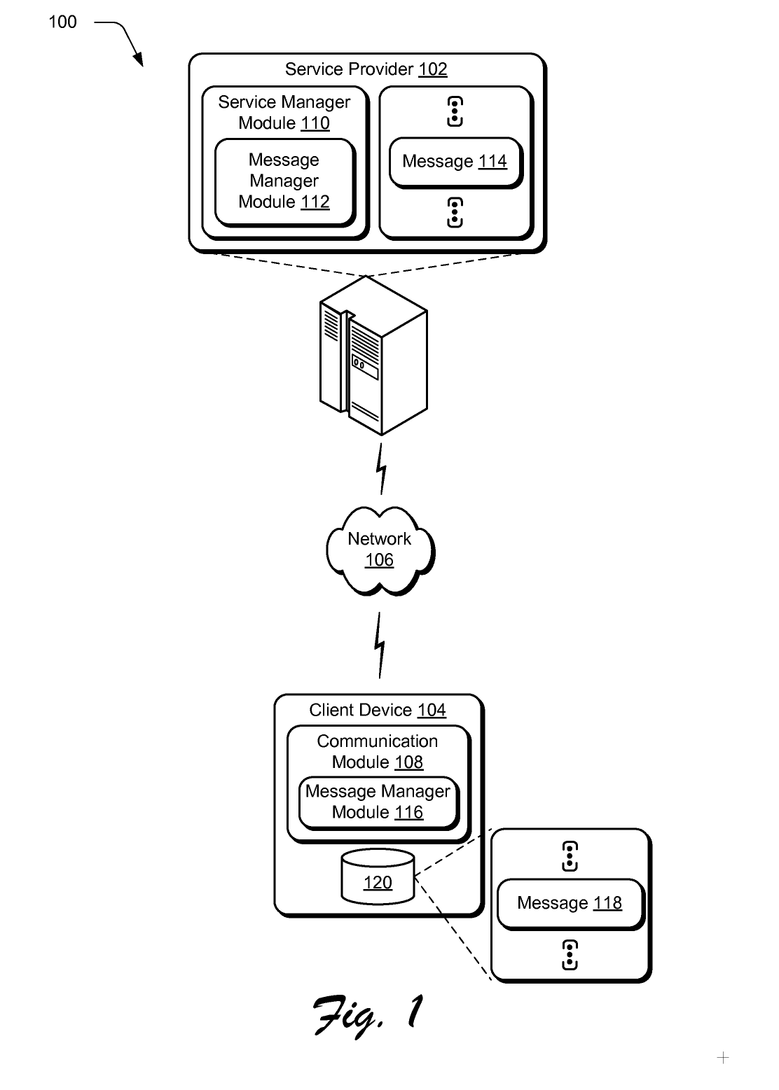

FIG. 1 is an illustration of an environment 100 in an example implementation that is operable to employ techniques described herein. The illustrated environment 100 includes a service provider 102 that is communicatively coupled to a client device 104 via a network 106. The service provider 102 and the client device 104 may be implemented using a wide variety of computing devices.

For example, a computing device may be configured as a computer that is capable of communicating over the network 106, such as a desktop computer, a mobile station, an entertainment appliance, a set-top box communicatively coupled to a display device, a wireless phone, a game console, a server, and so forth. Thus, the computing device may range from full resource devices with substantial memory and processor resources (e.g., servers, personal computers, game consoles) to a low-resource device with limited memory and/or processing resources (e.g., traditional set-top boxes, hand-held game consoles). Additionally, although a single computing device is shown (e.g., a server for the service provider 102), the computing device may be representative of a plurality of different devices, such as multiple servers utilized by a business to perform operations (e.g., a server farm), a remote control and set-top box combination, an image capture device and a game console configured to capture gestures, and so on.

A computing device may also include an entity (e.g., software) that causes hardware of the computing device to perform operations, e.g., processors, functional blocks, and so on. For example, the computing device may include a computer-readable medium that may be configured to maintain instructions that cause the computing device, and more particularly hardware of the computing device to perform operations. Thus, the instructions function to configure the hardware to perform the operations and in this way result in transformation of the hardware to perform functions. The instructions may be provided by the computer-readable medium to the computing device through a variety of different configurations.

One such configuration of a computer-readable medium is signal bearing medium and thus is configured to transmit the instructions (e.g., as a carrier wave) to the hardware of the computing device, such as via the network 106. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

The client device 104 is further illustrated as including a communication module 108. The communication module 108 is representative of functionality of the client device 104 to communicate via the network 106, such as with the service provider 102. For example, the communication module 108 may incorporate browser functionality to navigate the network 106, may be configured as a dedicated application having network access functionality, and so on.

The service provider 102 is illustrated as including a service manager module 110, which is representative of functionality to provide and manage access to one or more network services via the network 106. The service manager module 110, for instance, may incorporate revenue techniques to collect revenue for provision of the service, such as directly (e.g., for a fee), on a subscription basis, indirectly through inclusion of one or more advertisements, and so on.

One example of a service is illustrated through inclusion of a message manager module 112. The message manager module 112 is representative of functionality of the service provider 102 to manage communication of one or more messages 114. The messages 114, for instance, may be formed through interaction with the message manager module 112 by the client device 104 for communication to another user via a user account.

The messages 114 may also be representative of messages received by the service provider 102 to be communicated via user accounts associated with the service provider 102. The service provider 102, for instance, may receive a message 114 from another service provider and store that message in association with a user account. A user may then access the user account of the service provider 102 to gain access to the message 114, such as by using the communication module 108 of the client device 104. A variety of different messages 114 may be managed by the service provider 102, such as emails, SMS, MMS, instant messages, and other messages capable of being communicated electronically via the network 106 as described in the communication techniques section below.

Functionality of the message manager module 112, however, is not limited to implementation by the service provider 102. As such, the message manager module may be implemented by a variety of different entities, such as a third-party entity, by the client device 104 itself which is illustrated as inclusion of a message manager module 116 to manage messages 118 in storage 120 that is local to the client device 104, and so on. Therefore, although operation of the message manager module 112 is described at the service provider 102, this operation is not so limited and may be distributed throughout the environment 100 as well as other environments.

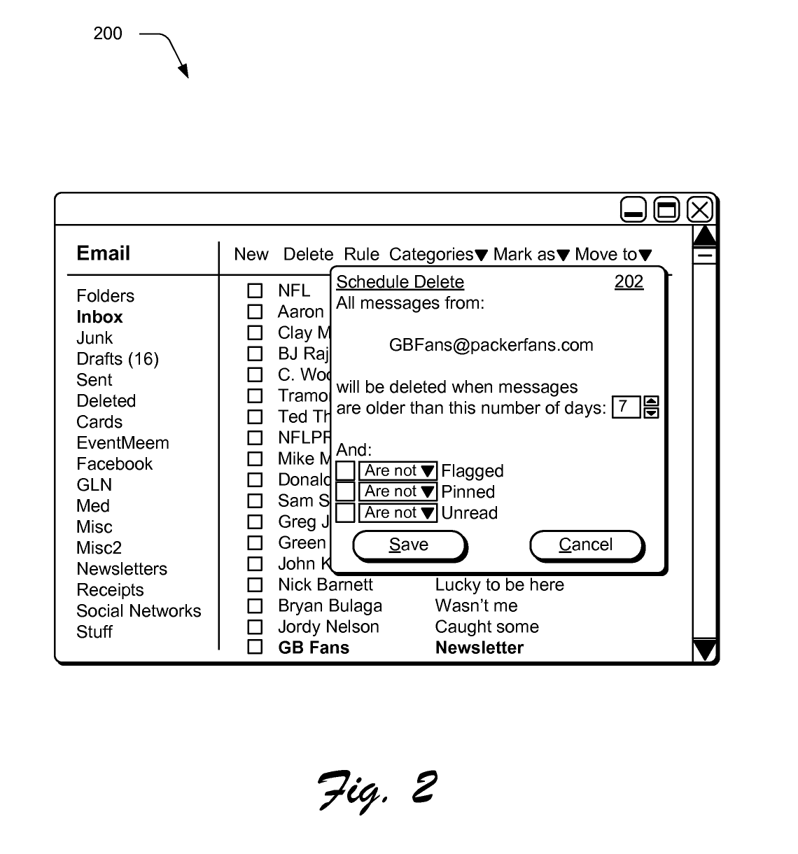

The message manager module 112 may manage the messages 114 in a variety of ways. For example, the message manager module 112 may expose functionality that may be used to created rules having conditions for an attribute that is mutable over time. The attributes, for instance, may change based on interaction with a user, such as whether a message is read or unread, whether the message has been flagged or not flagged, whether the message has been moved from one folder to another, whether the message was pinned or not pinned, whether the message was forwarded or not forwarded, replied to or not replied to, and so forth. Thus, these mutable attributes may describe interaction with the message and/or the lack thereof, which may be used in create of a rule to address such situations, further discussion of which may be found beginning in relation to FIG. 2.

Generally, any of the functions described herein can be implemented using software, firmware, hardware (e.g., fixed logic circuitry), manual processing, or a combination of these implementations. The terms “module” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks.

FIG. 2 is an illustration of a user interface 200 in an example implementation that exposes mutable message attribute functionality. The user interface 200 includes a list of folders on the left side of the user interface, with a folder “inbox” selected as depicted through use of bolding. Consequently, a center portion includes messages that are accessible through the inbox, which is below a menu of selectable items that includes “new,” “delete,” “rule,” “categories,” “mark as,” and “move to.”

The message “Green Bay” is illustrated as being selected through use of bolding. The message may be selected in a variety of ways, such as through use of a cursor control device (e.g., by “clicking”), a tap gesture, and so on.

A user may then select an option to create a rule that relates to the message, such as by selecting a “rule” item from the menu above. Selection of this item causes output of a menu of options (e.g., as a pop-up) that have a list of actions that may be performed relating to the message, such as to move, schedule delete, archive, and so on. In the illustrated user interface 200, the “schedule delete” option has been selected, causing output of a menu 202 in which criteria may be specified for create of a rule for a sender of the selected message.

The menu 202, for instance, includes text to verify an identity of a sender of the selected message, which in this case is “All messages from: GBFans@packerfans.com will be deleted when messages are older than this number of days.” The menu 202 then includes functionality that is exposed for a user to specify a number of days, which is illustrated as “7” and may be adjusted by the user using a cursor control device, gesture, text entry, and so on. In this way, a user may specify a deferred action to be performed by the rule, e.g., to delete messages from a specified sender at a specified point in time.

The menu 202 may also expose functionality to specify mutable attributes of one or more conditions for a message that may change over time. In the illustrated implementation, each attribute has a corresponding check box that is selectable by a user, e.g., using a cursor control device, gesture, voice command, and so on. Thus, a user may select one or more attributes, such as flagged, pinned, unread, and so on to be addressed by the rule. The user may also select conditions for the respective attributes, such as “are” or “are not” to specify whether the corresponding attribute is or is not to be met by the rule. These criteria may then be saved through selection of the “save” button in the menu 202, which may cause the message manager module 112 to create a rule having the specified deferred actions and conditions for mutable attributes, if any. In this way, a user may efficiently create a rule that includes an action that is based at least on part on whether a condition for a mutable attribute has been met. Further, this rule may also be configured for a “deferred action” that is to be performed at some time in the future, such as at periodic intervals, when a message has reached a certain age, and so on. Further discussion of these techniques may be found in relation to the following procedures.

### Example Procedures

The following discussion describes message techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the user interface 200 of FIG. 2, respectively.

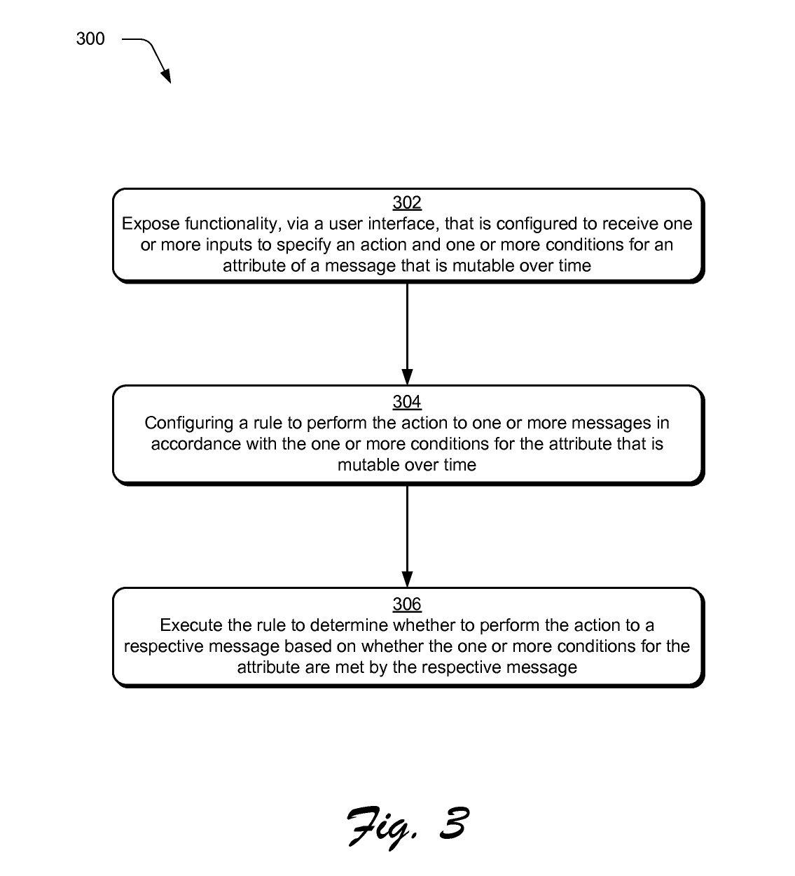

FIG. 3 depicts a procedure 300 in an example implementation in which a rule is configured to perform an action in accordance with one or more conditions for a mutable attribute. Functionality is exposed, via a user interface, that is configured to receive one or more inputs to specify an action and one or more conditions for an attribute of a message that is mutable over time (block 302). A variety of different actions may be specified through interaction with a user interface, such as to delete, move (e.g., to a particular folder of a user's account), archive, and so on.

Further, a variety of different conditions may be specified for the attributes, such as whether the attribute “is” or “is not” to be met. A user, for instance, may specify that the action is to be performed if the message is unread, e.g., to delete the message. In another instance, the user may specify that the action is to be performed is the message is read, e.g., archive the message.

A rule is configured to perform the action to one or more messages in accordance with the one or more conditions for the attribute that is mutable over time (block 304). The message manager module 112, for instance, may utilize the criteria entered by the user above to configure a rule to be used to manage messages as defined by the rule.

The rule is executed to determine whether to perform the action to a respective message based on whether the one or more conditions for the attribute are met by the respective message (block 306). The message manager module 112, for instance, may examine messages and match criteria with criteria specified in the rule to determine whether the rule is applicable. If the conditions are met by the message, the message manager module 112 may perform the specified action on the message.

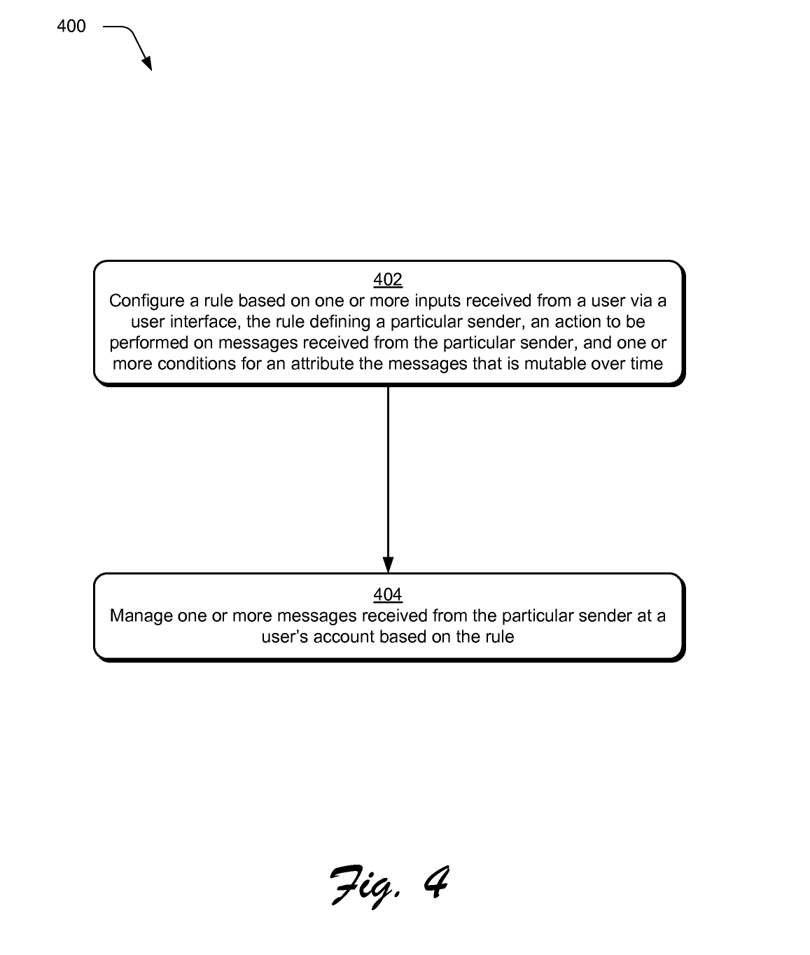

FIG. 4 depicts a procedure 400 in an example implementation in which a rule that specifies one or more conditions for a mutable attribute is used to manage messages received from a sender. A rule is configured based on one or more inputs received from a user via a user interface, the rule defining a particular sender, an action to be performed on messages received from the particular sender, and one or more conditions for an attribute the messages that is mutable over time (block 402). As before, a sender may be specified in a variety of ways, such as through a textual input (e.g., entering a sender's identification), through selection of a message from the sender, and so on. Additionally, a variety of actions may be specified as well as conditions for attributes that are mutable over time for the messages.

One or more messages received from the particular sender at a user's account are managed based on the rule (block 404). The rule, for instance, may specify a condition for a mutable attribute and thus the message manager module 112 may examine messages to determine whether the condition has been met. This may be performed as messages arrive, at predetermined intervals, in response to a change detected for a mutable attribute of a message, and so forth.

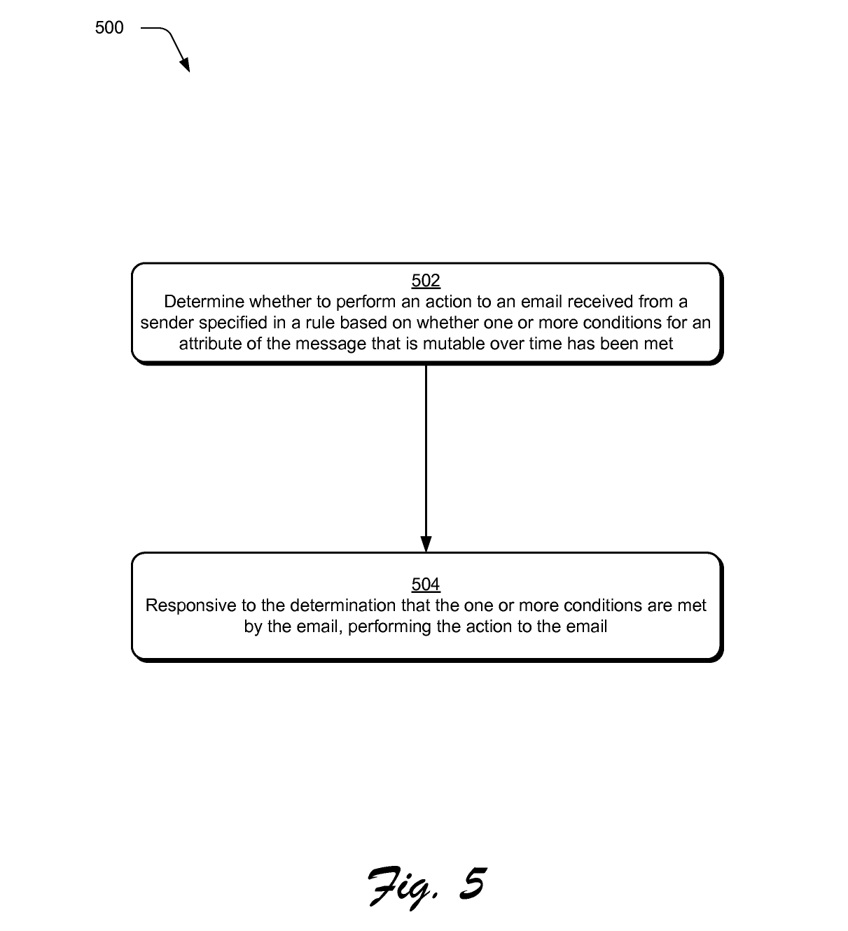

FIG. 5 depicts a procedure 500 in an example implementation in which an action is performed responsive to a determination that one or more conditions for a mutable attribute of a message are met by the message. A determination is made as whether to perform an action to an email received from a sender specified in a rule based on whether one or more conditions for an attribute of the message that is mutable over time has been met (block 502). The message manager module 112, for example, may compare criteria of a rule with corresponding criteria of messages to determine if the one or more conditions have been met by the examined messages.

Responsive to the determination that the one or more conditions are met by the email, the action is performed on the email (block 504) As before, a variety of different actions may be performed, such as to delete, move, archive, and so on for a message. Further, as described above this may be performed for a variety of conditions for mutable attributes, e.g., is the condition met for the corresponding attribute. Although email was described in the previously examples, these techniques may be performed for a variety of different communication techniques, examples of which are described in the following section.

Communication Techniques

The following provides further examples of the communication techniques that may be employed to deliver a message to a client device 104 as well as transmit the message by the client device 104.

Instant Messaging

Instant messaging is a popular text-based communication tool that enables two or more users to exchange messages via a network during an instant messaging session. When two users are online at the same time, for instance, instant messages may be exchanged in real time between the two users. Thus, the instant messages may be utilized to support a text conversation between the two users in a manner that mimics how the two users would participate in a typical spoken conversation.

Instant messaging is typically based on clients that facilitate connections between specified known users. Often, these known users can be associated with a “buddy list” or “contact list.” Although instant messaging is text-based, instant messaging may include additional features such as audio and/or video. For example, during an instant messaging session, users can see each other by using webcams or other video cameras, and/or hear each other using microphones and speakers.

In an implementation, instant messaging (IM) modules communicate with each other through use of one or more of a plurality of service providers. A service provider, for instance, may include an IM manager module, which is executable to route instant messages between the IM modules. For example, a client may cause the IM module to form an instant message for communication to a recipient. The IM module is executed to communicate the instant message to the service provider, which then executes the IM manager module to route the instant message to the recipient over the network. The recipient receives the instant message and executes the IM module to display the instant message.

Clients can also be communicatively coupled directly, one to another (e.g., via a peer-to-peer network). If so, the instant messages are communicated without utilizing the service provider.

SMS/MMS

Short Messaging Service (SMS) is communication tool that allows an exchange of short text messages between a fixed line or mobile phone device and fixed or portable devices over a network. Unlike instant messaging, SMS messages can be transmitted without both the sender and receiver being simultaneously online. SMS messages may be sent to a Short Message Service Center (SMSC), which may provide a store and forward mechanism. The SMSC may then attempt to send the SMS messages to intended recipients. If a recipient cannot be reached, the SMSC may queue the SMS message and retry at a later time. Some SMSCs, however, may provide a forward and forget option where transmission is attempted only once. Both senders and recipients of SMS messages may be identified by a phone number associated with the device being used to send or receive the SMS message.

In addition to text, SMS techniques have been expanded to include Multimedia Messaging Service (MMS) which allows the exchange of multimedia content along with the short text messages. Multimedia content may include digital photographs, videos, and the like. Similar to SMS messages, MMS messages may identify senders and recipients by their respective phone numbers.

Although MMS messages are similar to SMS messages, MMS messages are delivered in an entirely different way. For example, the multimedia content in the MMS message is first encoded in a manner similar to a Multipurpose Internet Mail Extension (MIME) email. The encoded MMS message is then forwarded to a Multimedia Messaging Service Carrier (MMSC), which is a carrier's MMS store and forward server. If the intended recipient is associated with a different carrier, the MMSC may forward the encoded message to the recipient's carrier using the Internet.

Once the MMSC has received the message, it may determine whether the recipient's device is configured to receive an MMS message. If the recipient's device is MMS capable, then the content is extracted and sent to a temporary storage server with a Hypertext Transfer Protocol (HTTP) front-end. An SMS control message containing a Uniform Resource Locator (URL) of the MMS content may then be sent to the recipient's device to trigger the recipient device's Wireless Access Protocol (WAP) browser to open and receive the MMS content from the URL. If, however, the recipient device does not support MMS messages, the MMSC may attempt to modify the MMS content into a format suitable for the recipient device before sending the MMS content to the recipient device.

Electronic Mail

Electronic mail, commonly referred to as email or e-mail, is a communication tool for exchanging digital messages from an author to one or more recipients over a network. A user can send an email message through his or her email program, which sends the email message to a mail server. The mail server may then forward the email message to another mail server or to a message store on the same mail server to be forwarded later. Unlike instant messages or SMS/MMS messages, email messages may identify senders and recipients by addresses including user names and domain names.

Email messages include an envelope, a header, and a body. The header may include fields that have names and values. Some example fields include From, To, CC, Subject, Date, and other information about the email message. The body may include basic content of the email message, as unstructured text, and may also include a signature block. The envelope is used to store communication parameters for delivery of the email message.

Email is one of the protocols included with the Transport Control Protocol/Internet Protocol (TCP/IP) suite of protocols. An example popular protocol for sending email is Simple Mail Transfer Protocol (SMTP), whereas example popular protocols for receiving emails include Post Office Protocol 3 (POP3) and/or Internet Message Access Protocol (IMAP). TCP/IP can be used as a communication language or protocol of the Internet, an intranet, or extranet. When an email message is sent over a network, the TCP manages assembly of the message or file into smaller packets, also referred to as “packetizing” the message. These packets are transmitted over the network, such as the Internet, and received by a TCP layer that reassembles the packets into the original message. The IP layer handles the address portion of each packet to ensure that each packet reaches the correct destination.

Web Service

Electronic messages may also be sent and received via a web service. A web service may include a software system designed to support interoperable machine-to-machine interaction over a network. Implementations of web services include web-based email services and/or web-based IM services. Web based services may include Extensible Markup Language (XML) messages that follow a Simple Object Access Protocol (SOAP) standard. Other web services may include Web Application Programming Interfaces (Web API), which may include a set of HTTP request messages along with a definition of the structure of response messages.

Web services may be used in a number of ways. Some example uses include Remote Procedure Calls (RPC), Service-Oriented Architecture (SOA), and Representational State Transfer (REST).

### Example System and Device

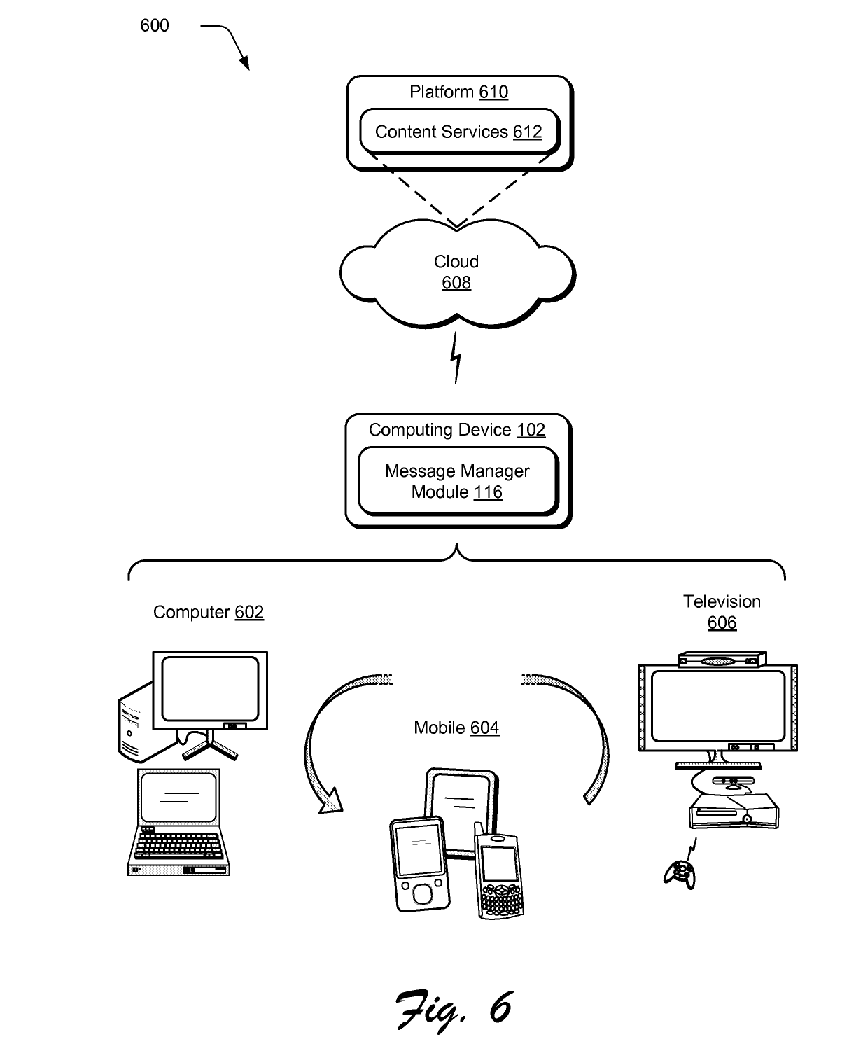

FIG. 6 illustrates an example system 600 that includes the computing device 102 as described with reference to FIG. 1. The example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 602, mobile 604, and television 606 uses. Each of these configurations includes devices that may have generally different constructs and capabilities, and thus the computing device 102 may be configured according to one or more of the different device classes. For instance, the computing device 102 may be implemented as the computer 602 class of a device that includes a personal computer, desktop computer, a multi-screen computer, laptop computer, netbook, and so on.

The computing device 102 may also be implemented as the mobile 604 class of device that includes mobile devices, such as a mobile phone, portable music player, portable gaming device, a tablet computer, a multi-screen computer, and so on. The computing device 102 may also be implemented as the television 606 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 608 includes and/or is representative of a platform 610 for content services 612. The platform 610 abstracts underlying functionality of hardware (e.g., servers) and software resources of the cloud 608. The content services 612 may include applications and/or data that can be utilized while computer processing is executed on servers that are remote from the computing device 102. Content services 612 can be provided as a service over the Internet and/or through a subscriber network, such as a cellular or Wi-Fi network.

The platform 610 may abstract resources and functions to connect the computing device 102 with other computing devices. The platform 610 may also serve to abstract scaling of resources to provide a corresponding level of scale to encountered demand for the content services 612 that are implemented via the platform 610. Accordingly, in an interconnected device embodiment, implementation of functionality of the functionality described herein may be distributed throughout the system 600. For example, the functionality may be implemented in part on the computing device 102 as well as via the platform 610 that abstracts the functionality of the cloud 608.

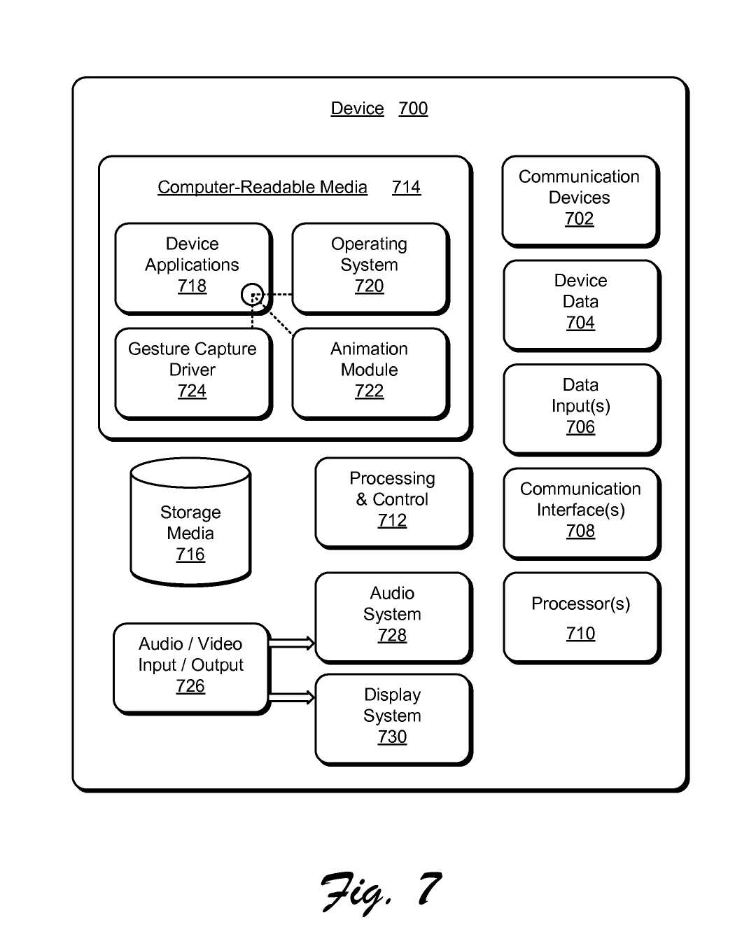

FIG. 7 illustrates various components of an example device 700 that can be implemented as any type of computing device as described with reference to FIGS. 1, 2, and 6 to implement embodiments of the techniques described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable instructions to control the operation of device 700 and to implement embodiments of the techniques described herein. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the techniques described herein. In this example, the device applications 718 include an interface application 722 and an input/output module 724 that are shown as software modules and/or computer applications. The input/output module 724 is representative of software that is used to provide an interface with a device configured to capture inputs, such as a touchscreen, track pad, camera, microphone, and so on. Alternatively or in addition, the interface application 722 and the input/output module 724 can be implemented as hardware, software, firmware, or any combination thereof. Additionally, the input/output module 724 may be configured to support multiple input devices, such as separate devices to capture visual and audio inputs, respectively.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more computing devices, the method comprising:
exposing functionality, via a user interface, that is configured to receive one or more inputs to specify an action and one or more conditions for an attribute of a message that is mutable over time; and
configuring a rule to perform the action to one or more messages in accordance with the one or more conditions for the attribute that is mutable over time.

2. A method as described in claim 1, wherein the one or more conditions for the attribute specify that the action is not to be performed responsive to a determination that the one or more conditions are met by a respective said message.

3. A method as described in claim 1, wherein the one or more conditions for the attribute specify that the action is to be performed responsive to a determination that the one or more conditions are met by a respective said message.

4. A method as described in claim 1, wherein the attribute is mutable over time in that that attribute is changeable over time for the one or more messages.

5. A method as described in claim 1, wherein the one or more inputs define a future point in time at which to perform the action.

6. A method as described in claim 1, wherein the action is to delete, move, or archive a corresponding said message.

7. A method as described in claim 1, wherein the one or more conditions for the attribute include whether a corresponding said message is read, unread, pinned, not pinned, flagged, not flagged, replied to, not replied to, forwarded, or not forwarded.

8. A method as described in claim 1, further comprising executing the rule to determine whether to perform the action to a respective said message based on whether the one or more conditions for the attribute are met by the respective said message.

9. A method as described in claim 1, wherein the message is an email, a SMS text, a MMS text, or an instant message.

10. A method implemented by one or more computing devices, the method comprising:
configuring a rule based on one or more inputs received from a user via a user interface, the rule defining a particular sender, an action to be performed on messages received from the particular sender, and one or more conditions for an attribute of the messages that is mutable over time; and
managing one or more messages received from the particular sender at a user's account based on the rule.

11. A method as described in claim 10, wherein the particular sender is specified through selection of a message received from the sender in a user interface.

12. A method as described in claim 10, wherein rule defines a point in time in which to make a determination of whether to apply the rule based on the one or more conditions.

13. A method as described in claim 10, wherein the action is to delete, move, or archive a corresponding said message.

14. A method as described in claim 10, wherein the one or more conditions for the attribute include whether a corresponding said message is read, unread, pinned, not pinned, flagged, not flagged, replied to, not replied to, forwarded, or not forwarded.

15. A method as described in claim 10, wherein the one or more conditions for the attribute specify that the action is not to be performed responsive to a determination that the one or more conditions are met by a respective said message.

16. A method as described in claim 10, wherein the one or more conditions for the attribute specify that the action is to be performed responsive to a determination that the one or more conditions are met by a respective said message.

17. A method implemented by one or more computing devices, the method comprising:
determining whether to perform an action to an email received from a sender specified in a rule based on whether one or more conditions for an attribute of the message that is mutable over time has been met; and
responsive to the determination that the one or more conditions are met by the email, performing the action to the email.

18. A method as described in claim 17, wherein the sender is specified through selection of a message received from the sender in a user interface.

19. A method as described in claim 17, wherein the determining is performed based on a point in time defined by the rule.

20. A method as described in claim 17, wherein:
the action is to delete, move, or archive a corresponding said message; and
the one or more conditions for the attribute include whether a corresponding said message is read, unread, pinned, not pinned, flagged, not flagged, replied to, not replied to, forwarded, or not forwarded.
